(19) United States
(12) Patent Application Publication
(10) Pub. No.: US 2010/0218177 A1
(43) Pub. Date: Aug. 26, 2010

(54) STORAGE APPARATUS AND SOFTWARE UPGRADE METHOD

(75) Inventor: Hiroyuki MIURA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/709,611

(22) Filed: Feb. 22, 2010

(30) Foreign Application Priority Data
Feb. 25, 2009 (JP) 2009-043171

(51) Int. Cl. G06F 9/44

(52) U.S. Cl. 717/170; 717/168

(57) ABSTRACT

A storage apparatus for storing a plurality of groups of data, the storage apparatus includes a storage area for storing software for managing the groups of data, and a meta-information storing section for storing a plurality of pieces of meta-information to manage the groups of data, respectively, in a first meta-information table according to the software. The storage apparatus includes a software upgrade section for, when receiving an upgrade command to install a new version software different from the already installed version software, performing a process for installing the new version software while leaving the already installed version software intact, and a table update section for formulating a new meta-information table by adding any one of a plurality of pieces of meta-information into the new meta information table piece by piece each time corresponding one of the groups of data is accessed.

### CROSS-REFERENCE TO RELATED APPLICATIONS

This application is based upon and claims the benefit of priority of the prior Japanese Patent Application No. 2009-43171, filed on Feb. 25, 2009, the entire contents of which are incorporated herein by reference.

### FIELD

The embodiment discussed herein is related to a storage apparatus, a software upgrade method, and a storage medium for storing a software upgrade program.

### BACKGROUND

In recent years, there have been storage apparatuses called “object access-type storages” (hereafter referred to as “CASs (content aware storages)” suitable for storing data to be left unchanged (called “fixed content”) for a long time. CASs employ an access method different from those employed by storage area networks (SANs) and network attached storages (NASs).

FIG. 11 is a drawing illustrating the access method employed by CASs. As illustrated in FIG. 11, an SAN 801 accesses data using a block access-type access method and an NAS 802 accesses data using a file access-type access method. On the other hand, a CAS 803 employs a content object access-type access method and accesses data on a content-by-content basis.

“Content” refers information obtained by packaging data (e.g., image data, etc.) and attributes (e.g., size, update date and time) of the data. CASs assign IDs (hereafter referred to as “content IDs”) to a plurality of pieces of content and access the pieces of content using the content IDs.

Hereafter, a configuration of a related-art CAS will be described. FIG. 12 is a drawing illustrating a configuration of a related-art CAS. As illustrated in FIG. 12, a related-art CAS 900 includes a computer (central processing device (CPU)) 945, a storage device 910, and an interface 901. The CPU 945 and storage device 910 execute content management software 920. The storage device 910, which is a device for storing content, includes a magnetic disk 911 and magnetic tapes 912a and 912b in an example illustrated in FIG. 12.

The content management software 920 includes a configuration definition storage section 930 and a content management service 940. The configuration definition storage section 930 is a storage device storing various types of information about the configuration of content and includes a content management table 931, an operation policy table 932, and an ID serial number 933. The content management table 931 contains an operation policy ID for identifying the operation policy of each content, a storage location, a storage date and time, an owner name, and the like in such a manner that these items correspond to the content ID of each content. The “operation policy” refers to information such as the conditions on which content is managed and is, for example, information indicating whether to store the content in the storage device 910 in a duplicated manner. The operation policy table 932 contains management policies in such a manner that the management policies correspond to operation policy IDs. The ID serial number 933 stores the numbers of content IDs to be assigned to new pieces of content.

When receiving a read command or write command from an API (application program interface) 11 of an upper apparatus, operation server 10, via an interface 901, the content management service 940 controls access to the storage device 910. For example, when receiving a read command, the content management service 940 acquires content using a content ID included in the read command and various types of information stored in the configuration definition storage section 930 and sends the acquired content to the operation server 10.

In this way, the related-art CAS manages pieces of content using content IDs. For this reason, the CAS depends on its platform to a lesser extent and is suitable for storing content for a long time. Reference documents are Japanese Laid-open Patent Publication Nos. 2004-199247 and 2005-222392.

Since CASs are storage apparatuses to be used for a long time, a new function may be added to the CASs, for example, by incorporating a disk medium conforming to a new standard thereinto after their operation. When a new function is added as described above, the content management software is often upgraded to correspond to the new function.

Unfortunately, the above-mentioned related-art CAS has a problem that the operation server and CAS itself may be deactivated for a long time to upgrade the content management software. In order to clarify such a problem, the steps for upgrading the content management software 920 will be described using the CAS 900 illustrated in FIG. 12 as an example.

In order to upgrade the content management software 920, first, the operation server 10 is deactivated. Then, the content management service 940 of the CAS 900 is stopped. Subsequently, the existing content management software 920 is uninstalled and then a new version of content management software 920 is installed. Then, the content management table 931 and operation policy table 932 are updated to the formats of those of the new version of content management software. Subsequently, the content management service is activated and then the operation server 10 is reactivated. In this way, the CAS 900 provides services to the operation server 10 using the new version of content management software.

As seen, in the case where the content management software is upgraded, the CAS 900 is deactivated. Also, in the above-mentioned upgrade work, the process of updating the content management table 931 and the like uses a long time. This is because recent storage apparatuses have larger capacities and store many pieces of content and thus the content management table 931 has a larger size as well. As a result, the deactivation time used to upgrade the content management software has been increased.

### SUMMARY

According to an aspect of the embodiment, a storage apparatus for storing a plurality of groups of data, the storage apparatus includes a storage area for storing software for managing the groups of data, and a meta-information storing section for storing a plurality of pieces of meta-information to manage the groups of data, respectively, in a first meta-information table according to the software, a software upgrade section for, when receiving an upgrade command to install a new version software different from the already installed version software, performing a process for installing the new version software while leaving the already installed version software intact, and a table update section for formulating a new meta-information table by adding any one of a plurality of pieces of meta-information into the new meta information table piece by piece each time corresponding one of the groups of data is accessed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a drawing illustrating a configuration of a storage apparatus according to an embodiment of the present technique.

FIG. 2 is a drawing illustrating an example of a service-version correspondence table.

FIG. 3 is a drawing illustrating an example of an ID table.

FIG. 4 is a drawing illustrating an example of an operation policy table.

FIG. 5A is a drawing illustrating an example of a content meta-information table.

FIG. 5B is a drawing illustrating an example of a content meta-information table.

FIG. 6 is a drawing illustrating an example of a content meta-information table.

FIG. 7 is a drawing illustrating an example of a content meta-information table.

FIG. 8 is a flowchart illustrating steps through which the storage apparatus according to this embodiment performs maintenance on content management software.

FIG. 9 is a flowchart illustrating steps of a read process that the storage apparatus according to this embodiment performs.

FIG. 10 is a flowchart illustrating steps of a write process that the storage apparatus according to this embodiment performs.

FIG. 11 is a drawing illustrating the access method of a CAS.

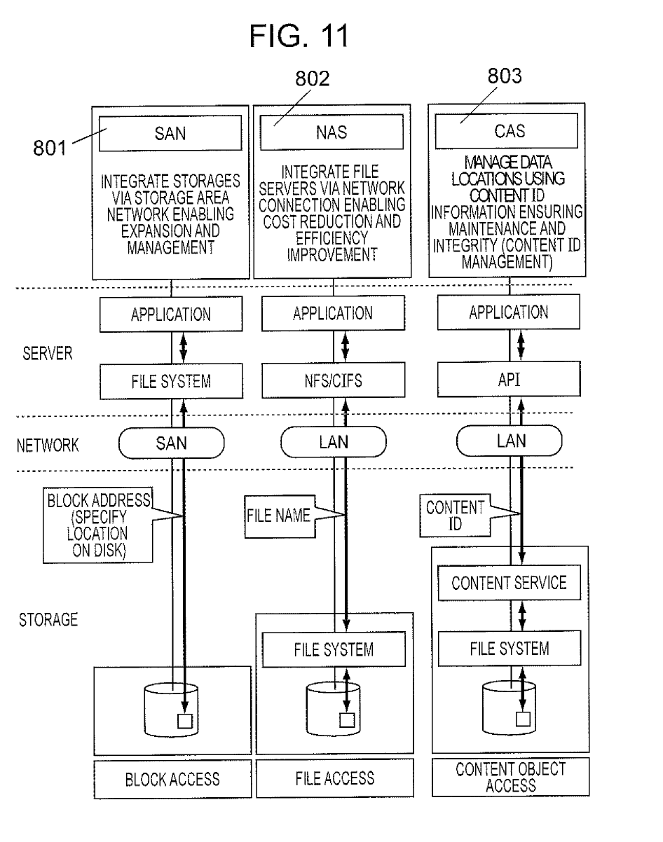

FIG. 12 is a drawing illustrating a configuration of a related-art CAS.

### DESCRIPTION OF EMBODIMENTS

Preferred embodiments of the present technique will be explained with reference to accompanying drawings. Now, an embodiment of a storage apparatus, a software upgrade method, and a storage medium for storing a software upgrade program disclosed in this application will be described in detail with reference to the accompanying drawings. Any of the storage apparatus, software upgrade method, and software upgrade program disclosed in this application is not limited to the embodiment. While the embodiment will be described using a CAS as an example of a storage apparatus, the storage apparatus, software upgrade method, and software upgrade program disclosed in this application are also applicable to other types of storage apparatuses that manage content using content management software.

First, a storage apparatus 100 according to this embodiment will be described. It is assumed that the storage apparatus 100 according to this embodiment is a CAS. The storage apparatus 100 may hold content management software of multiple versions. The storage apparatus 100 provides services realized by content management software of multiple versions. The “services realized by content management software” refer to, for example, performing a read process or write process in response to a read command or write command received from the operation server and sending the process result to the operation server.

Specifically, the storage apparatus 100 may provide both services realized by content management software of version V11 and those realized by content management software of version V12 thereof. Hereafter, “services realized by content management software” may be simply referred to as “services.” Also, “services realized by content management software of version n” may be simply referred to as “services of version n.”

Also, the storage apparatus 100 holds configuration definition tables containing various types of information about a plurality of pieces of content. Each configuration definition table contains attributes of a plurality of pieces of content, the version of content management software that manages the pieces of content, and the like.

The storage apparatus 100 according to this embodiment holds the configuration definition tables in a classified manner. Specifically, the storage apparatus 100 holds the configuration definition tables in such a manner that the tables are classified into tables used to be updated by a version upgrade and tables not used to be updated by a version upgrade. This is indicated to reduce the size of each configuration definition table to complete a configuration definition table update process (to be described later) within a short time.

The storage apparatus 100 holds the tables used to be updated by a version upgrade in such a manner that the tables are classified according to at least the version. This is indicated to reduce the time used to complete a configuration definition table update process, as described above. Also, since the versions may handle different items, the tables are held in such a classified manner. For example, an item that is not handled by version V11 software may be handled as a new item by new version V12 software including a new function. Specifically, in a case where the storage apparatus 100 holds content management software of versions V11 and V12, the storage apparatus 100 holds the configuration definition tables in such a manner that the tables are classified into a configuration definition table corresponding to version V11 and that corresponding to version V12.

When the storage apparatus 100 thus configured receives an upgrade command for upgrading the content management software, content management software of a new version is installed onto a predetermined storage area of the storage apparatus 100 with the already installed software left intact. For example, the predetermined storage area is set in a storage area of a memory of the CPU145 or the storage device 910.

At that time, the storage apparatus 100 does not update configuration definition tables corresponding to the plurality of old version software. Generally, when new version software is installed, the configuration definition tables are updated so that the already stored pieces of content are managed by the new version software. On the other hand, the storage apparatus 100 according to this embodiment performs a configuration definition table update process during its operation rather than doing it when the content management software is upgraded.

Specifically, when receiving a command for reading of content from the operation server during operation, the storage apparatus 100 identifies the version of content management software that manages the content. Subsequently, the storage apparatus 100 reads the content using a service of the identified version and sends the read content to the operation server.

If the content is managed by an old version software rather than the latest version software, the storage apparatus 100 updates a configuration definition table containing information about the content to a configuration definition table corresponding to the latest version. Since the storage apparatus 100 holds the configuration definition tables in a classified manner as described above, a process of updating a configuration definition table may be completed within a short time.

Also, when receiving a command for writing of content from the operation server, the storage apparatus 100 performs a write process using a service of the latest version software. Specifically, the storage apparatus 100 stores various types of information about the received content in a configuration definition table corresponding to the latest version software. Then, the storage apparatus 100 stores the received content in the storage device.

As seen, when the content management software is upgraded, the storage apparatus 100 according to this embodiment leaves the already installed content management software intact. Accordingly, the storage apparatus 100 holds the content management software of the multiple versions. Also, even when the content management software is upgraded, the storage apparatus 100 according to this embodiment does not perform a process of updating a configuration definition table. Thus, the storage apparatus 100 according to this embodiment may reduce the time used to upgrade the content management software.

Also, when receiving a command for reading of content managed by old version software, the storage apparatus 100 updates a configuration definition table storing various types of information about the content to a configuration definition table corresponding to the latest version software. Thus, the storage apparatus 100 may cause the latest version software to gradually manage the already stored pieces of content.

Also, the storage apparatus 100 according to this embodiment holds the configuration definition tables in such a manner that the tables are classified into tables used to be updated by a version upgrade and tables not used to be updated by a version upgrade and are classified on a version-by-version basis. Thus, the storage apparatus 100 may complete the above-mentioned configuration definition table update process within a short time. As a result, even when the storage apparatus 100 performs a configuration definition table update process during its operation, it may reduce the resource of the CPU or memory to be used for the update process.

Also, when receiving a command for writing of new content, the storage apparatus 100 according to this embodiment performs a write process using a service of the latest version. Thus, the storage apparatus 100 may cause the latest version of content management software to manage the new content.

As seen, the storage apparatus 100 according to this embodiment may upgrade the content management software within a short deactivation time, as well as may cause the latest version of content management software to gradually manage the stored pieces of content.

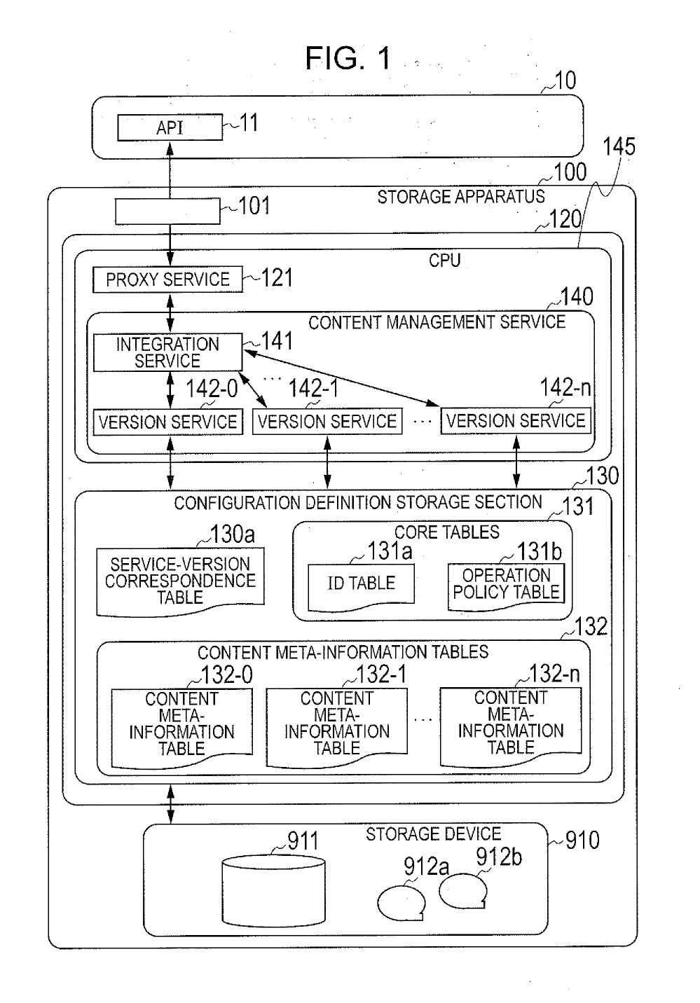

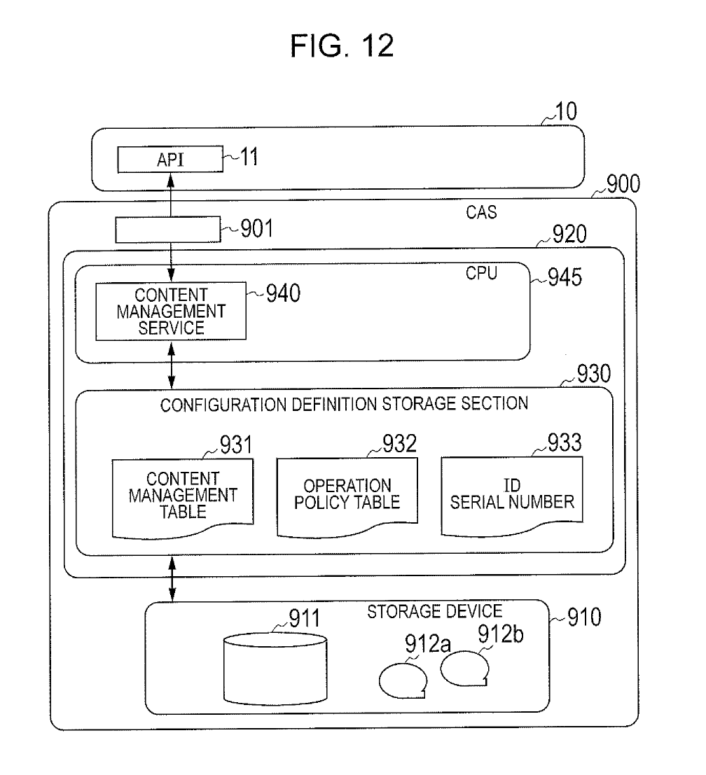

Next, a configuration of the storage apparatus 100 according to this embodiment will be described. FIG. 1 is a drawing illustrating a configuration of the storage apparatus 100 according to this embodiment. As illustrated in FIG. 1, the storage apparatus 100 includes a computer (central processing device (CPU)) 145, a storage device 910, and an interface 101. The CPU 145 and the storage device 910 execute content management software 120. The storage device 910 is similar to the storage device 910 illustrated in FIG. 12.

The content management software 120 provides services relating to access to the storage device 910. Specifically, the content management software 120 may provide services of different versions and includes a proxy service 121, a configuration definition storage section 130, and a content management service 140.

When the proxy service 121 receives a command for reading or writing of data from an API 11 of an upper apparatus, operation server 10, it stores the command in a predetermined buffer and sends the stored command to the content management service 140.

Specifically, when the content management service 140 is activated, the proxy service 121 sends the command stored in the buffer, to the content management service 140. In contrast, when the content management service 140 is deactivated, the proxy service 121 does not send the stored command to the content management service 140. Then, after the content management service 140 is activated, the proxy service 121 queues the command stored in the buffer and sends it to the content management service 140.

The configuration definition storage section 130 is a memory storing various types of information about the configuration of each content. The tables contained in the configuration definition storage section 130 are classified into a service-version correspondence table 130a, core tables 131, and content meta-information tables 132.

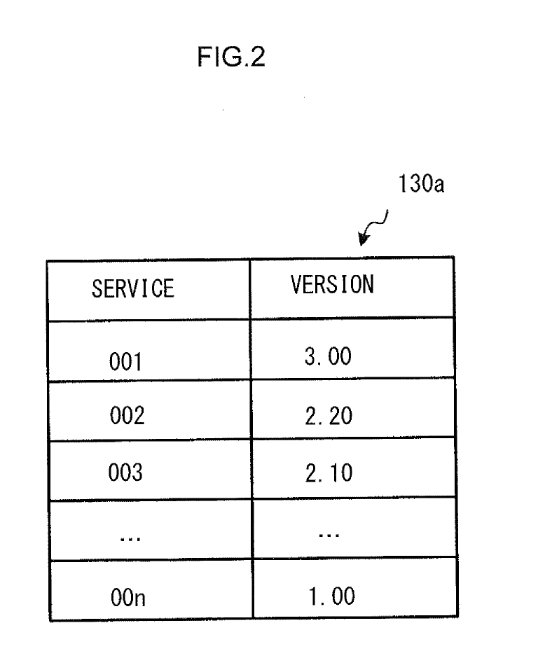

The service-version correspondence table 130a stores services that may be provided by the storage apparatus 100 and versions corresponding to the services. FIG. 2 illustrates an example of the service-version correspondence table 130a. As illustrated in FIG. 2, the service-version correspondence table 130a contains items, “service ID” and “version.” The “service ID” refers to information for identifying a service. The “version” refers to a version that provides a service identified by a service ID.

Specifically, the first row of the service-version correspondence table 130a illustrated in FIG. 2 indicates that a service identified by a service ID “001” is provided by version“3.00.” Also, the second row of the service-version correspondence table 130a illustrated in FIG. 2 indicates that a service identified by a service ID “002” is provided by version “2.20.” Also, FIG. 2 illustrates that services illustrated on upper rows are provided by more recent versions. That is, an example of FIG. 2 illustrates that among services that may be provided by the storage apparatus 100, the service “001” is provided by the latest version “3.00.”

In the description below, it will be assumed that the latest version is “3.00,” the version one generation earlier than the latest version is “2.20,” and the version two generations earlier than the latest version is “2.10.”

The core tables 131 are tables that do not need to be updated when the content management software is upgraded. In an example illustrated in FIG. 1, the core tables 131 include an ID table 131a and an operation policy table 131b.

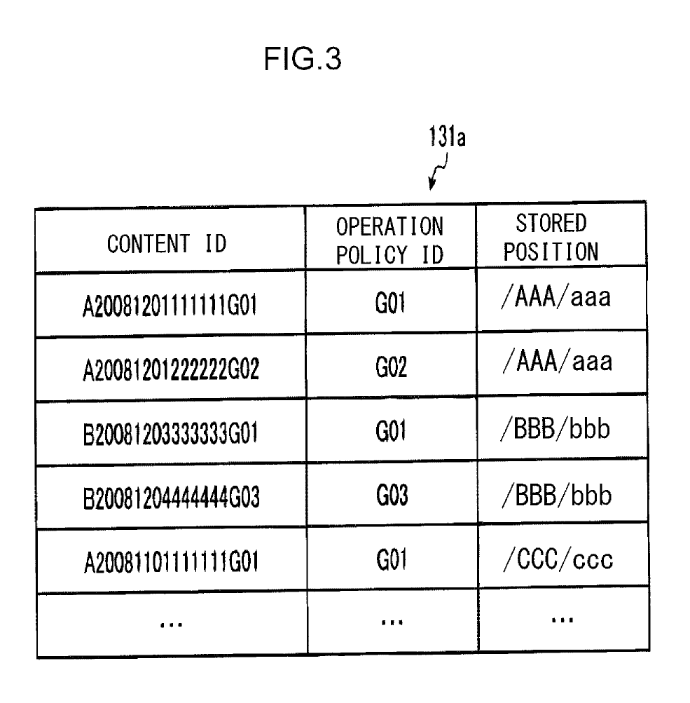

The ID table 131a stores information for managing pieces of content using content IDs. FIG. 3 illustrates an example of the ID table 131a. As illustrated in FIG. 3, the ID table 131a contains items “content ID,” “operation policy ID,” and “storage location.”

The “content ID” refers to information for identifying content. The “operation policy ID” refers to information for identifying the operation policy of content identified by a corresponding content ID. The “storage location” refers to the location (device name, path name, etc.) where content identified by a content ID is stored.

Specifically, the first row of the ID table 131a illustrated in FIG. 3 indicates that the operation policy ID of content identified by a content ID “A20081201111111G01” is “G01” and the content is stored in “/AAA/aaa.” Also, the fourth row of the ID table 131a illustrated in FIG. 3 indicates that the operation policy ID of content identified by a content ID “B20081204444444G03” is “G03” and the content is stored in “/BBB/bbb.”

A content ID is preferably given a name containing information about at least the corresponding server identifier, content storage date, and operation policy ID. A server identifier refers to information for identifying a server that has made a command for storage of content. A content storage date refers to the date and time (year/month/day/hour/minute/second) when content has been stored in the storage device 910. For example, a content ID “A20081201111111G01” illustrated in the first row of FIG. 3 is a combination of a server identifier “A,” a content storage date “20081201111111,” and an operation policy ID “G01.” The reason why a content ID is named in this way will be described later.

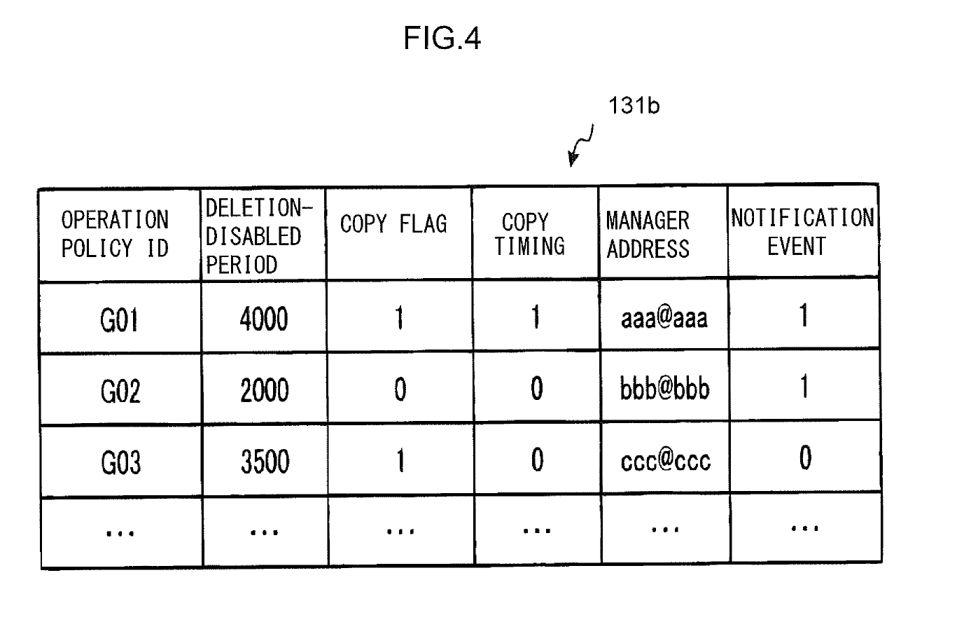

The operation policy table 131b stores various types of information about the operation policy (management conditions) of content for each operation policy ID. FIG. 4 illustrates an example of the operation policy table 131b. As illustrated in FIG. 4, the operation policy table 131b contains items “operation policy ID,” “deletion-disabled period,” “copy flag,” “copy timing,” “manager address,” and “notification event.”

The “operation policy ID” corresponds to the “operation policy ID” illustrated in FIG. 3 and refers to information for identifying an operation policy. The “deletion-disabled period” refers to the period during which content is stored in the storage device 910. In an example illustrated in FIG. 4, it is assumed that the deletion-disabled period is the number of days. The “copy flag” indicates whether content is stored in a duplicated manner. In FIG. 4, a copy flag “0” indicates that content is not stored in a duplicated manner and a copy flag “1” indicates that content is stored in a duplicated manner.

The “copy timing” indicates whether content is duplicated at the same time that it is stored. In FIG. 4, a copy timing “0” indicates that content is duplicated not at the same time that it is stored and a copy timing “1” indicates that content is duplicated at the same time that it is stored.

The “manager address” refers to a contact of the manager of content and is, for example, an email address. The “manager of content” here refers to, for example, the manager of a server that has made a command for storage of content. The “notification event” indicates whether, when an event such as a content storage error or a system stop advance notice occurs in the storage apparatus 100, notification about the event will be provided to the manager of the content. In FIG. 4, a notification event “0” indicates that notification about an event will not be provided to the manager and a notification event “1” indicates that notification about an event will be provided to the manager.

Specifically, an operation policy identified by an operation policy ID “G01” in the first row of the operation policy table 131b illustrated in FIG. 4 indicates that the period during which content is stored is “4000” days. The operation policy “G01” also indicates that the content is duplicated at the same that it is stored and that when an event occurs in the storage apparatus 100, notification about the event will be provided to the manager.

The content meta-information tables 132 are tables used to be updated when the content management software is upgraded. In an example illustrated in FIG. 1, the content meta-information tables 132 include content meta-information tables 132-0, 132-1, and 132-n.

The content meta-information tables 132-0, 132-1, . . . , and 132-n are classified according to at least the version and each store meta-information (attributes such as user information) about pieces of content. In the example illustrated in FIG. 1, it is assumed that the content meta-information table 132-0 is a table corresponding to the latest version (in this embodiment, version “3.00”) among the versions of content management software installed in the storage apparatus 100. Also, it is assumed that the content meta-information table 132-1 is a table corresponding to the version (in this embodiment, version “2.20”) one generation earlier than the latest version thereamong. Also, it is assumed that the content meta-information table 132-n is a table corresponding to the version n generations earlier than the latest version thereamong.

Also, the content meta-information tables 132-0, 132-1, . . . , and 132-n are classified according to predetermined criteria. For example, the content meta-information tables 132-0, 132-1, . . . , and 132-n are classified according to the year and month when content has been stored, the operation server where has made a command for storage of content, or the operation policy of content. For example, the content meta-information tables 132-0, 132-1, . . . , and 132-n are classified according to a combination of the above-mentioned content storage year and month, server, and operation policy. In the description below, it will be assumed that the storage apparatus 100 holds the content meta-information tables 132-0 and the like in such a manner that the tables are classified according to the year and month when content has been stored.

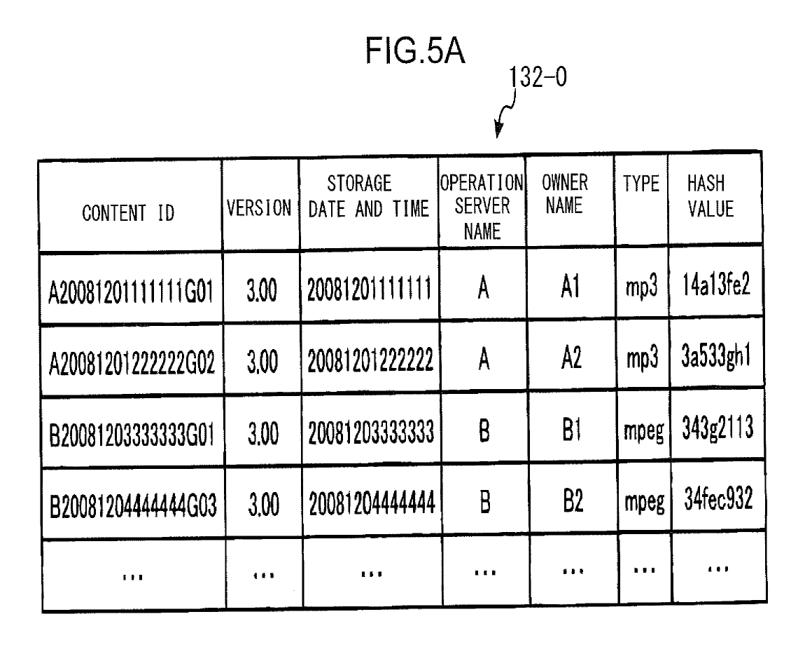

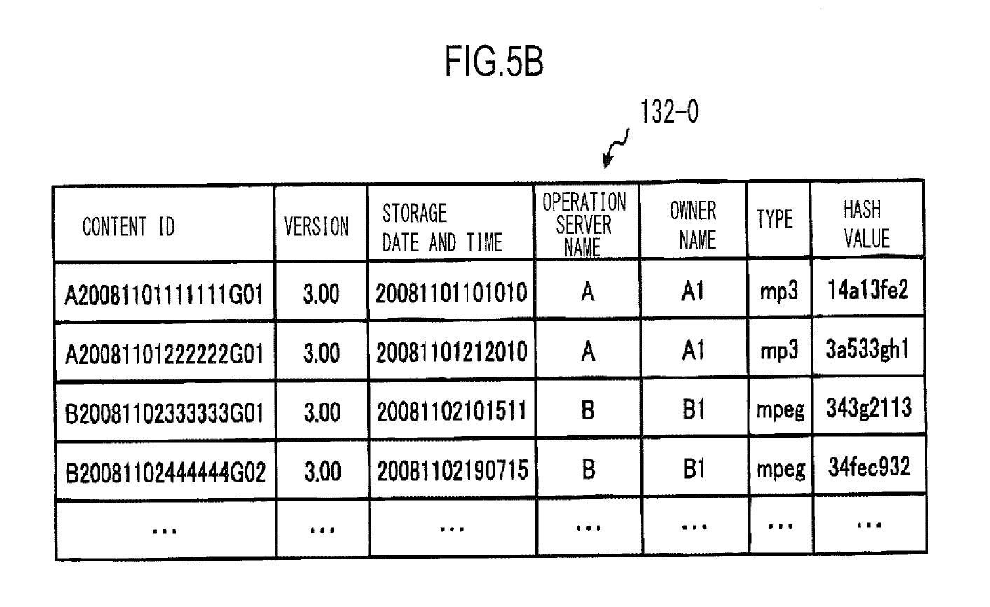

Referring now to FIGS. 5A, 5B, 6, and 7, the content meta-information tables 132-0, 132-1, . . . , and 132-n will be described specifically. FIGS. 5A and 5B are drawings illustrating an example of the content meta-information table 132-0. Specifically, FIGS. 5A and 5B are content meta-information tables corresponding to the latest version (in this embodiment, version “3.00”) of content management software installed in the storage apparatus 100. The difference between FIG. 5A and FIG. 5B is the content storage date. More specifically, the content meta-information table 132-0 illustrated in FIG. 5A stores meta-information about pieces of content stored in December 2008, while the content meta-information table 132-0 illustrated in FIG. 5B stores meta-information about pieces of content stored in November 2008.

As illustrated in FIGS. 5A and 58, the content meta-information table 132-0 contains items “content ID,” “version,” “storage date and time,” “operation server name,” “owner name,” “type,” and “hash value.” The “content ID” corresponds to “content ID” illustrated in FIG. 3. The “version” corresponds to “version” illustrated in FIG. 2. The “storage date and time” refers to the date and time (year/month/day/minute/second) when content identified by a corresponding content ID has been stored in the storage device 910.

The “operation server name” refers to the name of a server that has made a command for storage of content. The “owner name” refers to the name of the owner of content. The “type” refers to the type of content and corresponds to, for example, information such as “mp3” indicating an audio file or “mpeg” indicating a moving image file. The “hash value” refers to the hash value of content. The hash value is used in cases such as one where the storage apparatus 100 performs control for preventing storage of the same content in the storage device 910.

As illustrated in FIGS. 5A and 5B, the storage apparatus 100 manages even the content meta-information table corresponding to the same version in such a manner that the content meta-information table is divided into different content meta-information tables, for example, according to the year and month when content has been stored.

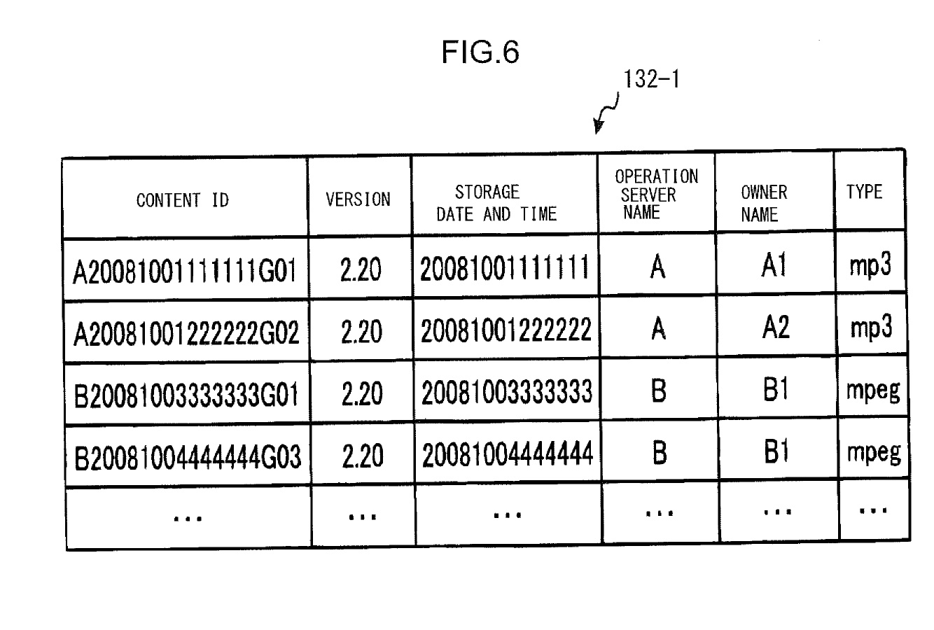

FIG. 6 is a drawing illustrating an example of the content meta-information table 132-1. Specifically, FIG. 6 is a content meta-information table corresponding to the one-generation-earlier version (in this embodiment, version “2.20”). The content meta-information table 132-1 illustrated in FIG. 6 does not contain the item “hash value” unlike the content meta-information tables 132-0 illustrated in FIGS. 5A and 58.

This means that while the services of up to version “2.20” do not manage the hash value of content, the services of version “3.00” manage the hash value of content. In other words, this means that the services of the version “3.00” include a new function of performing control for preventing storage of the same content as described above. As seen, when a new function is added to the services due to a version upgrade, managed information may be changed.

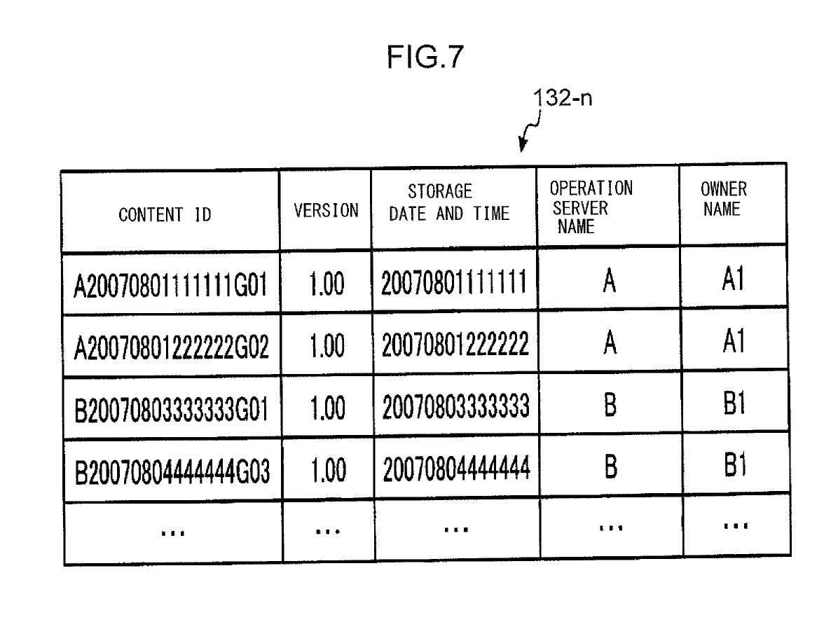

FIG. 7 is a drawing illustrating an example of the content meta-information table 132-n. Specifically, FIG. 7 is a content meta-information table corresponding to the n-generation-earlier version (in this embodiment, version “1.00”). The content meta-information table 132-n illustrated in FIG. 7 does not contain the item “type” unlike the content meta-information table 132-1 illustrated in FIG. 6.

Although not illustrated, the storage apparatus 100 according to this embodiment also holds the content meta-information tables 132-1 and 132-n in such a manner that each content meta-information table is divided into different tables according to the year and month when content has been stored, like the content meta-information table 132-0.

Back in FIG. 1, when the content management service 140 receives a read command or a write command from the proxy service 121, it controls access to the storage device 910. Specifically, the content management software 140 performs access control using services such as an integration service 141 and version services 142-0, 142-1, . . . , and 142-n.

The integration service 141 receives a read command or write command from the proxy service 121 and causes the version service 142-0, 142-1, . . . , or 142-n to perform access control. Hereafter, a process that the integration service 141 performs when receiving a read command and a process that it performs when receiving a write command will be described separately.

First, the process that the integration service 141 performs when receiving a read command will be described. When receiving a command for reading of content via the proxy service 121, the integration service 141 retrieves a content meta-information table storing information about the content, according to information contained in the content ID, such as “content storage year, month, and date.”

Subsequently, the integration service 141 acquires a version corresponding to the content, from the retrieved content meta-information table. Then, the integration service 141 acquires a service ID corresponding to the acquired version, from the service-version correspondence table 130a. Subsequently, the integration service 141 instructs the version service identified by the acquired service ID, that is, one of the version services 142-0, 142-1, . . . , and 142-n to perform a read process.

Subsequently, the integration service 141 determines whether the version acquired from the content meta-information table is the latest version. If the version is not the latest, the integration service 141 performs a content meta-information table update process. Specifically, the integration service 141 transfers the content meta-information table 132 storing information about the content, that is, one of the content meta-information tables 132-1, . . . , and 132-n to the content meta-information table 132-0 corresponding to the latest version.

If there is no content meta-information table 132-0, which is the transfer destination, the integration service 141 creates a new content meta-information table 132-0. An example of such a case is a case where there is no content meta-information table 132-0 corresponding to the year and month when the content has been stored. If there is a content meta-information table 132-0, which is the transfer destination, the integration service 141 transfers various types of information stored in the content meta-information table (132-1 or the like), which is the transfer source, to the content meta-information table 132-0.

Also, if the destination content meta-information table 132-0 contains an item different from those of the source content meta-information table (132-1 or the like), the integration service 141 creates information to be stored in the item. For example, in order to transfer information stored in the content meta-information table 132-1 to the content meta-information table 132-0, the integration service 141 calculates the hash value of each content before performing a transfer process.

The storage apparatus 100 may store items different between the versions, in a predetermined storage area. For example, the storage apparatus 100 may store information indicating that the difference between the items of version “2.20” and those of version “3.00” is “hash value” and the differences between the items of version “1.00” and those of version “3.00” are “hash value” and “type.” Thus, the integration service 141 may recognize an item to be created in performing a content meta-information table update process.

Subsequently, when there is no longer information to be transferred in the content meta-information table corresponding to the old version by the performance of the content meta-information table update process, the integration service 141 uninstalls (deletes) the old version software.

The above-mentioned process that the integration service 141 performs will be described using two cases. In the cases illustrated below, it will be assumed that the service-version correspondence table 130a is as illustrated in FIG. 2 and that the content meta-information tables 132-0, 132-1, . . . , and 132-n are as illustrated in FIGS. 5A, 5B, 6, and 7.

First, a case where the integration service 141 receives a read command including a content ID' A20081201111111G01″ will be described. In this case, first, the integration service 141 extracts a content storage year and month “200812” from the content ID. Then, the integration service 141 retrieves the content meta-information table 132-0 (FIG. 5A) that manages pieces of content stored in December 2008. Subsequently, the integration service 141 acquires version “3.00” corresponding to the content ID “A20081201111111G01,” from the content meta-information table 132-0.

As seen, by giving a content ID a name including information such as “server identifier” and “content storage date,” the integration service 141 may retrieve the intended content meta-information table, based on the information contained in the content ID. As a result, the integration service 141 may speed up a process of retrieving a content meta-information table.

If the content meta-information tables 132-0 and the like are classified according to the operation server or operation policy, the integration service 141 retrieves the intended content meta-information table, according to “server identifier” or “operation policy ID” contained in the content ID.

Subsequently, the integration service 141 acquires a service ID “001” corresponding to version “3.00,” from the service-version correspondence table 130a. Then, the integration service 141 instructs the version service 142-0 indicated by the acquired service ID “001” to perform a read process. Since version “3.00” acquired from the service-version correspondence table 130a is the latest version, the integration service 141 completes the process.

Next, a case where the integration service 141 receives a read command including a content ID “A20081001111111G01” will be described. In this case, first, the integration service 141 extracts a content storage year and month “200810” from the content ID and retrieves the content meta-information table 132-1 illustrated in FIG. 6, based on the extracted content storage year and month. Then, the integration service 141 acquires version “2.20” corresponding to the content ID “A20081001111111G01,” from the content meta-information table 132-1.

Subsequently, the integration service 141 acquires a service ID “002” corresponding to version “2.20,” from the service-version correspondence table 130a. Then, the integration service 141 instructs the version service 142-1 indicated by the acquired service ID “002” to perform a read process.

Since version “2.20” acquired from the service-version correspondence table 130a is not the latest version, the integration service 141 updates the content meta-information table 132-1 to a content meta-information table corresponding to the latest version. In this embodiment, the content meta-information tables are classified according to the storage year and month. As illustrated in FIGS. 5A, 5B, and 6, the storage year and months according to which the content meta-information tables 132-0 are classified differ from that according to which the content meta-information table 132-1 is classified. For this reason, the integration service 141 may not transfer information stored in the content meta-information table 132-1 to the existing content meta-information tables 132-0.

Accordingly, the integration service 141 creates a new meta-information table 132-0. Then, the integration service 141 calculates the hash values of pieces of content identified by content IDs stored in the content meta-information table 132-1. Subsequently, the integration service 141 transfer the calculated hash values, as well as various types of information stored in the content meta-information table 132-1, to the created new content meta-information table 132-0.

Subsequently, the integration service 141 determines whether any other information exists in the content meta-information table 132-1 corresponding to version “2.20.” If any other information does not exist in the content meta-information tables 132-1, services of version “2.20” will be no longer used. Accordingly, the integration service 141 uninstalls (deletes) version “2.20” of content management software.

Next, a process that the integration service 141 performs when receiving a write command will be described. When the integration service 141 receives a write command via the proxy service 121, it instructs the version service 142-0, whose version is the latest, to perform a write process.

The version services 142-0, 142-1, and 142-n provide a read or write process performance service, according to an instruction from the integration service 141. In the example illustrated in FIG. 1, it is assumed that the version service 142-0 provides a service of the latest version, the version service 142-1 provides a service of the version one generation earlier than the latest version, and the version service 142-n provides a service of the version n generations earlier than the latest version.

Hereafter, a read process that the version service 142-0, 142-1, . . . , or 142-n (hereafter referred to as “version service 142-0 or the like”) performs and a write process that the version service 142-0 performs will be described specifically.

First, a read process that the version service 142-0 or the like performs will be described. When the version service 142-0 or the like receives an instruction for performance of a read process from the integration service 141, it acquires an operation policy ID and a storage location corresponding to a content ID contained in the read instruction, from the ID table 131a.

Subsequently, using the acquired operation policy ID as a key, the version service 142-0 or the like acquires various types of information such as a deletion-disabled period, from the operation policy table 131b. Based on the acquired information, the version service 142-0 or the like determines, for example, whether to notify the manager of occurrence of an event.

Subsequently, using a content ID included in the read command as a key, the version service 142-0 or the like acquires meta-information such as an operation server name, from the content meta-information table 132-0, 132-1, . . . , or 132-n. At that time, the version service 142-0 or the like acquires various types of information from the corresponding content meta-information table 132-0, 132-1, . . . , or 132-n. For example, the version service 142-0 of the latest version acquires meta-information from the content meta-information table 132-0 corresponding to the latest version. Also, the one-generation-earlier version service 142-1 acquires meta-information from the content meta-information table 132-1 corresponding to the one-generation-earlier version.

The version service 142-0 or the like performs a predetermined process, based on the meta-information acquired from the content meta-information table 132-0 or the like. The “predetermined process” refers to, for example, a process of determining whether the owner has an access right, using the owner name. Such a process may vary among the versions to which the version services 142-0 and the like correspond. For example, the version service 142-0 may perform various types of control using a hash value, while the version service 142-1 may not perform control using a hash value.

Subsequently, the version service 142-0 or the like acquires content from the storage device 910, according to the storage location acquired from the ID table 131a and sends the acquired content to the operation server 10.

Next, a write process that the version service 142-0 performs will be described. Among the version services 142-0, 142-1, . . . , and 142-n, the version service 142-0 performs a write process. This is because the integration service 141 instructs the version service 142-0 of the latest version to perform a write process.

When the version service 142-0 receives a command for performance of a write process, it stores content included in the write command, in the storage device 910. Then, the version service 142-0 assigns a content ID to the stored content. Specifically, the version service 142-0 assigns a content ID containing at least “server identifier,” “content storage date,” and “operation policy ID,” as described above.

Subsequently, the version service 142-0 stores meta-information about the content included in the write command, in the content meta-information table 132-0. In a case where the content meta-information tables 132-0 are classified according to the storage month, as in this embodiment, the version service 142-0 stores the meta-information in the content meta-information table 132-0 corresponding to the year and month where the content is stored.

Subsequently, the version service 142-0 stores the assigned content ID, the operation policy ID of the stored content, and the location in which the content is stored, in the ID table 131a, as well as sends the content ID to the operation server 10.

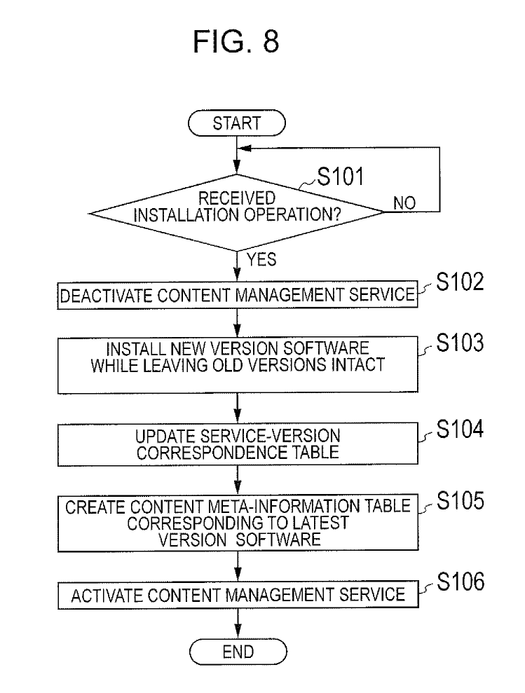

Referring now to FIG. 8, the steps for installing new version software onto the above-mentioned storage apparatus 100 will be described. FIG. 8 is a flowchart illustrating steps through which the storage apparatus 100 according to this embodiment performs maintenance on the content management software.

As illustrated in FIG. 8, when the storage apparatus 100 receives an upgrade command for installing a new version software (YES in step S101), it deactivates the content management service 140 (step S102).

Subsequently, the new version software is installed onto the storage apparatus 100 with the old versions software left intact (step S103). Then, the storage apparatus 100 updates the service-version correspondence table 130a (step S104). For example, when content management software of version “4.00” is installed, the storage apparatus 100 adds a combination of a predetermined service ID and version “4.00” to the service-version correspondence table 130a as a new record.

Subsequently, the storage apparatus 100 creates a content meta-information table corresponding to the content management software of the installed version (step S05). At this time, the created content meta-information table contains no record. This is because, when the new version of content meta-information table is installed, the storage apparatus 100 according to this embodiment does not perform a content meta-information table update process.

Subsequently, the storage apparatus 100 activates the content management service 140 (step S106). As seen, the new version software is installed onto the storage apparatus 100 according to this embodiment without updating the content meta-information tables. This may reduce the time used for an installation process. Also, the storage apparatus 100 according to this embodiment receives a read command or write command from the operation server 10 via the proxy service 121 even during installation of the new version software. This eliminates the need to deactivate the storage apparatus 100.

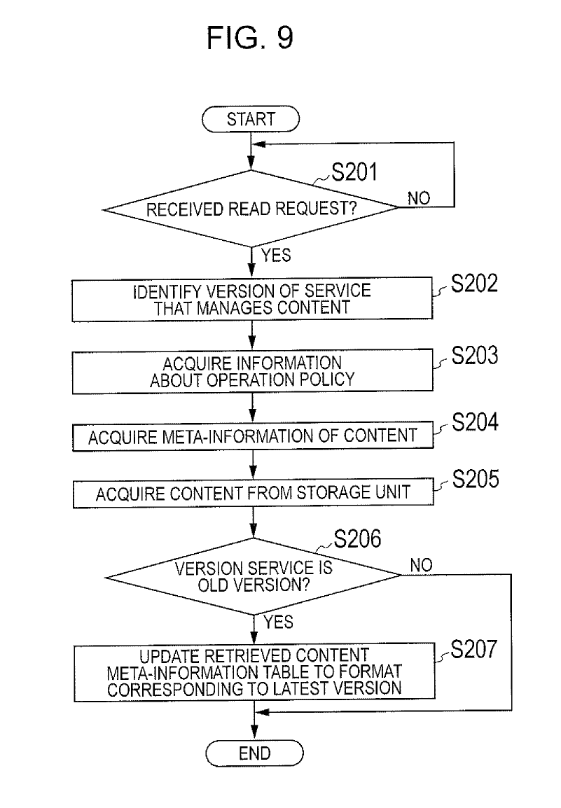

Next, steps of a read process that the storage apparatus 100 according to this embodiment performs will be described. FIG. 9 is a flowchart illustrating steps of a read process that the storage apparatus 100 according to this embodiment performs.

As illustrated in FIG. 9, when receiving a read request via the proxy service 121 (YES in step S201), the integration service 141 identifies the version corresponding to a service that manages content identified by a content ID contained in the read request (step S202). Specifically, the integration service 141 acquires the version from the content meta-information table 132-0, 132-1, . . . , or 132-n using the content ID.

Subsequently, the integration service 141 acquires a service ID corresponding to the version identified in step S202, from the service-version correspondence table 130a. Then, the integration service 141 instructs a service identified by the acquired service ID, that is, any one of the version services 142-0, 142-1, . . . , and 142-n to perform a read process.

Upon receipt of the instruction from the integration service 141, the version service 142-0 or the like acquires an operation policy ID and a storage location corresponding to the content ID, from the ID table 131a. Then, the version service 142-0 or the like acquires various types of information corresponding to the acquired operation policy ID, from the operation policy table 131b (step S203).

Subsequently, the version service 142-0 or the like acquires meta-information corresponding to the content ID, from the content meta-information tables 132-0, 132-1, . . . , or 132-n (step S204). The version service 142-0 or the like performs processes, such as an access right check, based on the acquired meta-information.

Subsequently, the version service 142-0 or the like acquires content from the storage device 910, according to the storage location stored in the ID table 131a in a manner corresponding to the content ID and sends the acquired content to the operation server 10 (step S205).

If the version identified in step S202 is not the latest version (YES in step S206), the integration service 141 performs a content meta-information table update process (step S207). For example, if the content ID included in the read request is “A20081001111111G01,” the version service 142-1 acquires various types of information from the content meta-information table 132-1 illustrated in FIG. 6. At this time, the integration service 141 updates the content meta-information table 132-1 to the format of the content meta-information table corresponding to the latest version illustrated in FIG. 5A or 5B. Then, the integration service 141 updates information contained in the content meta-information table 132-1 to information corresponding to the latest version (in this embodiment, “3.00”).

Subsequently, when there is no longer any content meta-information table corresponding to a predetermined old version by the performance of the content meta-information table update process, the integration service 141 uninstalls the predetermined old version software.

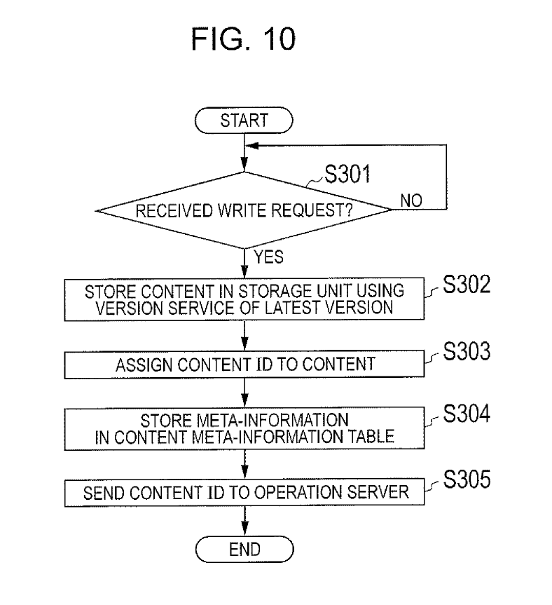

Next, steps of a write process that the storage apparatus 100 according to this embodiment performs will be described. FIG. 10 is a flowchart illustrating steps of a write process that the storage apparatus 100 according to this embodiment performs.

As illustrated in FIG. 10, when receiving a write request via the proxy service 121 (YES in step S301), the integration service 141 instructs the version service 142-0, whose version is the latest, to perform a write process.

Upon receipt of the instruction from the integration service 141, the version service 142-0 stores content included in the write request, in the storage device 910 (step S302). Then, the version service 142-0 assigns a content ID to the stored content (step s303). Then, the version service 142-0 stores meta-information about the content in the content meta-information table 132-0 (step S304).

Subsequently, the version service 142-0 adds the assigned content ID and corresponding information to the ID table 131a as a new a record, as well as sends the content ID to the operation server 10 (step S305).

As described above, when content management software of a new version is installed, the storage apparatus 100 leaves the already installed content management software intact. Thus, the storage apparatus 100 holds the content management software of the multiple versions. Also, when new version software is installed, the storage apparatus 100 according to this embodiment does not perform a configuration definition table update process. Also, when the storage apparatus 100 according to this embodiment receives a command for reading of content managed by content management software of an old version, it updates a content meta-information table storing meta-information about the content to a content meta-information table corresponding to the latest version software.

Thus, the storage apparatus 100 according to this embodiment may upgrade the content management software within a short deactivation time, as well as may cause the latest version software to gradually manage the stored pieces of content.

In the above-mentioned embodiment, any content meta-information table is not updated at the timing when content management software of a new version is installed and an update process is performed when a read command is received; however, the storage apparatus 100 may update a specific content meta-information table at such an installation timing.

For example, when content management software of a new version is installed, the storage apparatus 100 may update a most recently accessed content meta-information table to a content meta-information table corresponding to the latest version. This is because there is a high possibility that the most recently accessed content will be accessed again. This may prevent the most recently accessed content meta-information table from undergoing an update process during operation of the storage apparatus 100, as well as may perform content meta-information table update processes in a distributed manner both during installation of content management software of a new version and during operation.

Also, in the above-mentioned embodiment, the content meta-information table storing the content ID included in the read request is updated to the content meta-information table corresponding to the latest version; however, the storage apparatus 100 may also update other content meta-information tables simultaneously.

For example, assume that meta-information about content C11 is stored in a content meta-information table M11 and that meta-information about content C12 is stored in a content meta-information table M12. Also, assume that the content C11 and content C12 have a close relationship. The “close relation ship” means, for example, that the content C11 and content C12 are related to each other and there is a high possibility that when receiving a command for reading of the content C11, the storage apparatus 100 will also receive a command for reading of the content C12. In this case, when receiving a command for reading of the content C11, the storage apparatus 100 may update not only the content meta-information table M11 but also the content meta-information table M12 to a content meta-information table corresponding to the latest version.

Also, in the above-mentioned embodiment, a content ID includes at least “server identifier,” “content storage date,” and “operation policy ID” in order to increase the efficiency of a process of retrieving information from a content meta-information table; however, a content ID does not always need to include the above-mentioned information such as “server identifier” as long as the content ID is information that allows identifying content uniquely. In a case where a content ID does not include information such as “server identifier,” the integration service 141 acquires the version without retrieving the intended content meta-information table. In this case, the storage apparatus 100 includes the ID serial number 933 as illustrated in FIG. 12 in order to assign content IDs by which pieces of content may be identified uniquely.

The elements of the illustrated apparatus represent function concepts and may not need to be physically configured as illustrated. That is, the specific distributed or integrated aspect of each apparatus is not limited to what is illustrated and all or any part thereof may be configured in a functionally or physically distributed or integrated manner according to various loads, the operating conditions, or the like. All or any part of the processing functions that each apparatus performs may be achieved by a computer (CPU) and a program that is analyzed and executed by the computer or achieved by hardware using wired logic.

The process steps, control steps, specific names, and information, including various types of data and parameters, illustrated in this specification or the drawings may be changed arbitrarily unless otherwise specified.

Applications of the elements of the storage apparatus, expressions, or any combinations of the elements disclosed in this application to methods, apparatuses, systems, computer programs, storage media, data structures, and the like are also effective as other aspects of the present technique.

Also, the storage apparatus may be configured by providing a software upgrade program to a computer (CPU).

Such a software upgrade program may be previously stored in a memory of a computer, a “transportable physical medium” such as a computer-readable hard disk (HDD), flexible disk (FD), CD-ROM, or optical disk, or “another computer (or server)” connected to the computer via a public line, Internet, LAN, WAN, or the like and may be read therefrom and executed by the computer.

The storage apparatus disclosed in this application is advantageous in that content management software may be upgraded within a short deactivation time.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A storage apparatus for storing a plurality of groups of data, the storage apparatus comprising:
a storage area for storing software for managing the groups of data;
a meta-information storing section for storing a plurality of pieces of meta-information to manage the groups of data, respectively, in a first meta-information table according to the software;
a software upgrade section for, when receiving an upgrade command to install a new version software different from the already installed version software, performing a process for installing the new version software while leaving the already installed version software intact; and
a table update section for formulating a new meta-information table by adding any one of a plurality of pieces of meta-information into the new meta information table piece by piece each time corresponding one of the groups of data is accessed.

2. The storage apparatus according to claim 1, further comprising:
an identification section for, when receiving a command for reading of data from an upper apparatus, identifying a version of the software, the version of the software managing the data; and
a data reading section for reading the data using software of the version identified by the identification section among the plurality of versions of the software stored in the software storing area,
wherein, if the version identified by the identification section is not the latest version, the table update section formulates a new meta-information table corresponding to the latest version software by adding a piece of meta-information about the data read by the data reading section.

3. The storage apparatus according to the claim 2, further comprising:
a deletion section for deleting software of the version that has no longer any corresponding meta-information table by a formulation of the new meta-information table by the table update section.

4. The storage apparatus according to claim 1, further comprising:
a writing section for, when receiving a command for writing of data, storing the data using the software of the latest version among the plurality of versions of the software stored in the storage area.

5. A software upgrade method for upgrading software for managing the groups of data stored by a storage apparatus, the software upgrade method comprising:
storing a plurality of pieces of meta-information to manage the groups of data, respectively, in a first meta-information table according to the software, the software stored in a storage area;
performing a process for installing a new version software while leaving the already installed version software intact when receiving an upgrade command to install the new version software different from the already installed version software; and
formulating a new meta-information table by adding any one of a plurality of pieces of meta-information into the new meta information table piece by piece each time corresponding one of the groups of data is accessed.

6. The software upgrade method according to claim 5, further comprising:
when receiving a command for reading of data from an upper apparatus, identifying a version of the software, the version of the software managing the data; and
reading the data using software of the version identified by the identification among the plurality of versions of the software stored in the storage area,
wherein, if the version identified by the identification is not the latest version, the formulating process includes formulating a new meta-information table corresponding to the latest version software by adding a piece of meta-information about the data read by the reading process.

7. The software upgrade method according to the claim 6, further comprising:
deleting software of the version that has no longer any corresponding meta-information table by the formulation of the new meta-information table.

8. The software upgrade method according to claim 5, further comprising:
when receiving a command for writing of data, storing the data using the software of the latest version among the plurality of versions of the software stored in the storage area.
